(19) United States
(12) Patent Application Publication
(10) Pub. No.: US 2015/0170837 A1
(43) Pub. Date: Jun. 18, 2015

(54) Dielectric K Value Tuning of HAH Stack for Improved TDDB Performance of Logic Decoupling Capacitor or Embedded DRAM

(71) Applicant: Intermolecular, Inc., San Jose, CA (US)

(72) Inventors: Sucharita Madhukar, San Jose, CA (US); Nobumichi Fuchigami, Sunnyvale, CA (US); Imran Hashim, Saratoga, CA (US); Wen Wu, Pleasanton, CA (US)

(73) Assignee: Intermolecular, Inc., San Jose, CA (US)

(21) Appl. No.: 14/133,496

(22) Filed: Dec. 18, 2013

(51) Int. Cl. H01G 4/008; H01G 4/10

(52) U.S. Cl. CPC H01G 4/008; H01G 4/10

(57) ABSTRACT

A hafnium oxide-aluminum oxide-hafnium oxide (HAH) based multilayer stack is used as the dielectric material in the formation of decoupling capacitors employed in microelectronic logic circuits. In some embodiments, the thickness of the aluminum oxide layer in the HAH multilayer stack varies between 0.1 nm and 1 nm. In some embodiments, the thickness of the two hafnium oxide layers varies between about 3.0 nm and 4.5 nm.

### TECHNICAL FIELD

The present disclosure relates generally to the formation of decoupling capacitors used in microelectronic logic circuits.

### BACKGROUND

The power supply on a logic chip must accommodate variations in current draw from different parts of the on-chip circuit. Typically, there is a time lag between the changes in voltage within the circuit before the power supply responds. This requirement can be met by having an on-chip metal-insulator-metal (MIM) capacitor, consisting of a high-k dielectric layer formed between bottom and top electrodes. The capacitor can be used to provide a steady source of current during the response time of the power supply. The requirements for this high-k dielectric include providing sufficient capacitance or equivalent oxide thickness (EOT) (e.g. relative to silicon dioxide) to meet the requirements for charge storage, and having sufficiently low leakage to allow charge to be stored for at least 1 ms. Furthermore, the high-k dielectric should be able to operate reliably at typical sense voltages (˜1.5V) for the lifetime of the product (e.g. typically >10 years). Finally, the high-k dielectric should have a low defect density (e.g. pinhole defects or grain boundaries) which can be a source of leakage or charge loss in these capacitors. The defect density places an upper limit on the size of the capacitor that can be used in a chip. In some cases, the capacitor is divided into smaller capacitors which are connected in parallel to minimize the occurrence of these pinhole or grain boundary defects.

There is a need to develop dielectric materials and MIM capacitor stacks that meet these requirements as decoupling capacitors for advanced and future logic circuits.

### SUMMARY

The following summary of the disclosure is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

In some embodiments, a hafnium oxide-aluminum oxide-hafnium oxide (HAH) based multilayer stack is used as the dielectric material in the formation of decoupling capacitors employed in microelectronic logic circuits. In some embodiments, the thickness of the aluminum oxide layer in the HAH multilayer stack varies between 0.1 nm and 1 nm. In some embodiments, the thickness of the two hafnium oxide layers varies between about 3 nm and 4.5 nm.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 illustrates a simplified cross-sectional view of semiconductor layer stacks fabricated in accordance with some embodiments.

FIG. 2 presents a data table in accordance with some embodiments.

FIG. 3 presents data for current density versus EOT for capacitor stacks according to some embodiments.

FIG. 4 presents data for current density versus voltage for capacitor stacks according to some embodiments.

FIG. 5 presents data for failure probability versus time to break down for capacitor stacks according to some embodiments.

FIG. 6 presents data for time to break down versus stress voltage for various capacitor stacks according to some embodiments.

FIG. 7 presents data for current versus time for capacitor stacks at different stress voltages according to some embodiments.

FIG. 8 presents data for failure probability versus time to break down for capacitor stacks according to some embodiments.

FIG. 9 presents data for time to break down versus stress voltage for various capacitor stacks according to some embodiments.

FIG. 10 presents data for current versus time for capacitor stacks at different stress voltages according to some embodiments.

FIG. 11 presents a flow chart for forming a multilayer dielectric stack according to some embodiments.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

It must be noted that as used herein and in the claims, the singular forms “a,” “an,” and “the” include plural referents unless the context clearly dictates otherwise. Thus, for example, reference to “a layer” may also include two or more layers, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the modifier “about” or “approximately” is used, the stated quantity can vary by up to 10%. Where the modifier “substantially equal to” or “substantially the same” is used, the two quantities may vary from each other by no more than 5%.

The term “horizontal” as used herein will be understood to be defined as a plane parallel to the plane or surface of the substrate, regardless of the orientation of the substrate. The term “vertical” will refer to a direction perpendicular to the horizontal as previously defined. Terms such as “above”, “below”, “bottom”, “top”, “side” (e.g. sidewall), “higher”, “lower”, “upper”, “over”, and “under”, are defined with respect to the horizontal plane. The term “on” means there is direct contact between the elements. The term “above” will allow for intervening elements.

The discussion herein will use a simple capacitor stack as an illustration. The capacitor stack will include a first electrode layer (sometimes called a bottom electrode layer), a dielectric layer, and a second electrode layer (sometimes called a top electrode layer). Those skilled in the art will understand that each of the first electrode layer, dielectric layer, and second electrode layer may include multiple layers and multiple materials. In some embodiments, an additional layer will be inserted between the first electrode layer and the dielectric layer. As used herein, this layer will be labeled a “flash” layer. In some embodiments, an additional layer will be inserted between the dielectric layer and the second electrode layer. As used herein, this layer will be labeled a “capping” layer. The terms “first”, “bottom”, “second”, “top”, “flash”, “capping”, etc. are included for convenience and to assist in the description of the capacitor stack and are not meant to be limiting.

As used herein, a material (e.g. a dielectric material or an electrode material) will be considered to be “crystalline” if it exhibits greater than or equal to 30% crystallinity as measured by a technique such as x-ray diffraction (XRD).

Dopants can be added to the dielectric material to increase the k-value and/or decrease the leakage current. As used herein, the dopant may be electrically active or not electrically active. The definition excludes residues and impurities such as carbon, etc. that may be present in the material due to inefficiencies of the process or impurities in the precursor materials. The concentration of the dopant is one factor that affects the crystallinity of the dielectric material. Other factors that affect the crystallinity of the dielectric material comprise annealing time, annealing temperature, film thickness, etc. Generally, as the concentration of the dopant is increased, the crystallization temperature of the dielectric material increases.

The term “nanolaminate”, as used herein, will be understood to be defined as a material or layer that is formed from the deposition of a plurality of sub-layers. Typically, the sub-layers include different materials and the different sub-layers are alternated in a predetermined ratio of thicknesses and/or compositions.

As used herein, the phrase “high k” will be understood to refer to a material, layer, and/or multilayer stack that has a dielectric constant of greater than 7.

Those skilled in the art will appreciate that each of the layers discussed herein and used in the decoupling MIM capacitor may be formed using any common formation technique such as atomic layer deposition (ALD), plasma enhanced atomic layer deposition (PE-ALD), atomic vapor deposition (AVD), ultraviolet assisted atomic layer deposition (UV-ALD), chemical vapor deposition (CVD), plasma enhanced chemical vapor deposition (PECVD), or physical vapor deposition (PVD). Generally, because of the complex morphology of the decoupling capacitor structure, ALD, PE-ALD, AVD, or CVD are preferred methods of formation. However, any of these techniques are suitable for forming each of the various layers discussed herein. Those skilled in the art will appreciate that the teachings described herein are not limited by the technology used for the deposition process.

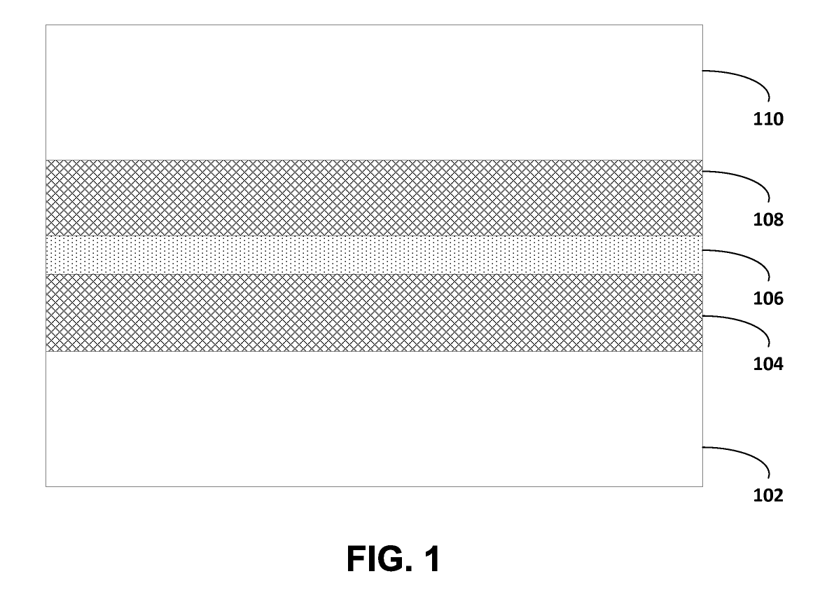

In FIG. 1, a capacitor stack is illustrated using a simple planar structure. Those skilled in the art will appreciate that the description and teachings herein can be readily applied to any simple or complex capacitor morphology. The drawings are for illustrative purposes only and do not limit the application of the present disclosure.

Hafnium oxide is a high k (e.g. k value ˜25) dielectric material that has been evaluated for applications such as a gate dielectric material or as a capacitor dielectric material. One application of hafnium oxide is as the dielectric material in decoupling capacitors used in logic circuits. In some embodiments, two layers of hafnium oxide are formed on either side of an aluminum oxide layer to form a dielectric stack. Typically, the two hafnium oxide layers may be either crystalline or amorphous. Typically, the aluminum oxide layer is amorphous. The two hafnium oxide layers contribute to the high k value of the dielectric stack, while the aluminum oxide layer contributes to lowering the leakage current through the dielectric stack.

Leakage current in dielectric materials can be due to mechanisms such as Schottky emission, Frenkel-Poole defects (e.g. oxygen vacancies (Vₒₓ) or grain boundaries), or Fowler-Nordheim tunneling, and the like. Schottky emission, also called thermionic emission, is a common mechanism and is the heat-induced flow of charge over an energy barrier whereby the effective barrier height of a MIM capacitor controls leakage current. The effective barrier height is a function of the difference between the work function of the electrode and the electron affinity of the dielectric. The electron affinity of a dielectric is closely related to the conduction band offset of the dielectric. The Schottky emission behavior of a dielectric layer is generally determined by the properties of the dielectric/electrode interface. Frenkel-Poole emission allows the conduction of charges through a dielectric layer through the interaction with defect sites such as vacancies, grain boundaries, and the like. As such, the Frenkel-Poole emission behavior of a dielectric layer is generally determined by the dielectric layer's bulk properties. Fowler-Nordheim emission allows the conduction of charges through a dielectric layer through tunneling. As such, the Fowler-Nordheim emission behavior of a dielectric layer is generally determined by the physical thickness of the dielectric layer. This leakage current is a primary driving force in the adoption of high-k dielectric materials. The use of high-k materials allows the physical thickness of the dielectric layer to be as thick as possible while maintaining the required capacitance.

Generally, as the dielectric constant of a material increases, the band gap of the material decreases. This leads to high leakage current in the device. As a result, without the utilization of countervailing measures, capacitor stacks implementing high-k dielectric materials may experience large leakage currents. High work function electrodes (e.g., electrodes having a work function of greater than 5.0 eV) may be utilized in order to counter the effects of implementing a reduced band gap high-k dielectric material within the decoupling capacitor. Metals, such as platinum, gold, ruthenium, and ruthenium oxide are examples of high work function electrode materials suitable for inhibiting device leakage in a decoupling capacitor having a high-k dielectric material. The noble metal systems, however, are prohibitively expensive when employed in a mass production context. Moreover, electrodes fabricated from noble metals often suffer from poor manufacturing qualities, such as surface roughness and poor adhesion, and form a contamination risk in the fab.

Additionally, decoupling capacitor stacks may undergo various refinement process steps after fabrication. These refinement processes may include post-fabrication chemical and thermal processing (i.e., oxidation or reduction). For instance, after initial decoupling capacitor stack fabrication, a number of high temperature (up to about 600 C) processes may be applied to complete the device fabrication. During these subsequent process steps, the decoupling capacitor materials must remain chemically, physically, and structurally stable. They must maintain the structural, compositional, physical, and electrical properties that have been developed. Furthermore, they should not undergo significant interaction or reaction which may degrade the performance of the decoupling capacitor.

FIG. 1 illustrates a simplified cross-sectional view of decoupling capacitor stacks fabricated in accordance with some embodiments. A first hafnium oxide layer, 104, is formed above a bottom electrode, 102, of a decoupling capacitor. Examples of suitable electrode materials include metals, metal alloys, conductive metal oxides, conductive metal silicides, conductive metal nitrides, doped polysilicon, or combinations thereof. Examples of suitable materials for the bottom electrode layer include titanium nitride, titanium aluminum nitride, titanium silicon nitride, tantalum nitride, tantalum aluminum nitride, tantalum silicon nitride, doped polysilicon, or combinations thereof. First hafnium oxide layer, 104, typically has a thickness between 3 nm and 4.5 nm.

Aluminum oxide layer, 106, is formed above the first hafnium oxide layer, 104. Aluminum oxide layer, 106, typically has a thickness between 0.1 nm and 1 nm. Aluminum oxide layer, 106, will remain amorphous during a subsequent anneal step.

A second hafnium oxide layer, 108, is formed above aluminum oxide layer, 106. Second hafnium oxide layer, 108, typically has a thickness between 3 nm and 4.5 nm.

Top electrode layer, 110, is formed above second hafnium oxide layer, 108. Examples of suitable electrode materials include metals, metal alloys, conductive metal oxides, conductive metal silicides, conductive metal nitrides, doped polysilicon, or combinations thereof. Examples of suitable materials for the top electrode layer include titanium nitride, titanium aluminum nitride, titanium silicon nitride, tantalum nitride, tantalum aluminum nitride, tantalum silicon nitride, doped polysilicon, or combinations thereof.

In some embodiments, the hafnium oxide layer can be formed using ALD. The hafnium precursor may include an inorganic precursor such as HfCl₄, or an amine-based organometallic precursor. Typical oxidants for use in the ALD deposition of hafnium oxide include one or more of oxygen, water, ozone, or nitrous oxide. In some embodiments, the oxidant used in the ALD deposition of hafnium oxide includes ozone at a concentration between 1% and 20% (weight %) in oxygen. In some embodiments, the oxidant used in the ALD deposition of hafnium oxide includes water. During the ALD deposition, the substrate may be heated to a temperature between about 200C and about 500C. Advantageously, the substrate may be heated to a temperature of about 300C. During the ALD deposition, the hafnium precursor may be introduced into the reaction chamber in pulses, wherein each pulse lasts for between about 1 second and about 120 seconds. Advantageously, the pulse length of the hafnium precursor may be about 60 seconds. During the ALD deposition, the oxidant may be introduced into the reaction chamber in pulses, wherein each pulse lasts for between about 1 second and about 60 seconds. Advantageously, the pulse length of the oxidant may be about 1 second. Typically, the reaction chamber is purged between the precursor pulses and the oxidant pulses with an inert or reactive gas. Advantageously, the pulse length of the purge gas may be about 15 seconds. During the ALD deposition, the pressure within the reaction chamber may be between about 0.1 Torr and 2 Torr. Advantageously, the pressure within the reaction chamber may be between about 0.4 Torr and 0.9 Torr.

In some embodiments, the aluminum oxide layer can be formed using ALD. The aluminum precursor may include an organic precursor such as tri-methyl aluminum (TMA). However, other aluminum precursors may also be used. Typical oxidants for use in the ALD deposition of aluminum oxide include one or more of oxygen, water, ozone, or nitrous oxide. In some embodiments, the oxidant used in the ALD deposition of aluminum oxide includes ozone at a concentration between 1% and 20% (weight %) in oxygen. In some embodiments, the oxidant used in the ALD deposition of aluminum oxide includes water. During the ALD deposition, the substrate may be heated to a temperature between about 200C and about 500C. Advantageously, the substrate may be heated to a temperature of about 300C. During the ALD deposition, the aluminum precursor may be introduced into the reaction chamber in pulses, wherein each pulse lasts for between about 1 second and about 60 seconds. Advantageously, the pulse length of the aluminum precursor may be about 2 seconds. During the ALD deposition, the oxidant may be introduced into the reaction chamber in pulses, wherein each pulse lasts for between about 1 second and about 60 seconds. Advantageously, the pulse length of the oxidant may be about 15 seconds. Typically, the reaction chamber is purged between the precursor pulses and the oxidant pulses with an inert or reactive gas. Advantageously, the pulse length of the purge gas may be about 15 seconds. During the ALD deposition, the pressure within the reaction chamber may be between about 0.1 Torr and 2 Torr. Advantageously, the pressure within the reaction chamber may be between about 0.4 Torr and 0.9 Torr.

Advantageously, all of the layers in the HAH multilayer dielectric stack remain in an amorphous phase after deposition and during subsequent processing. This reduces one of the leakage current paths (i.e. Frenkel-Poole emission) as discussed previously. The leakage current through an HAH stack wherein the two hafnium oxide layers are amorphous will be lower than the leakage current through an HAH stack wherein the two hafnium oxide layers are crystalline. The EOT of the HAH stack will be a combination of the EOT from the two hafnium oxide layers and the EOT of the aluminum oxide layer, weighted by the thickness of the respective layers. The EOT of each of the layers is strongly influenced by the k-value of the material. As the thickness of the aluminum oxide layer is increased, the EOT will increase and the effective k-value of the HAH stack will decrease. Forming the HAH stack with amorphous hafnium oxide layers would allow the thickness of the aluminum oxide layer to be reduced, while maintaining acceptable leakage current performance. The reduction in the thickness of the aluminum oxide layer would result in a decrease in the effective EOT of the HAH stack.

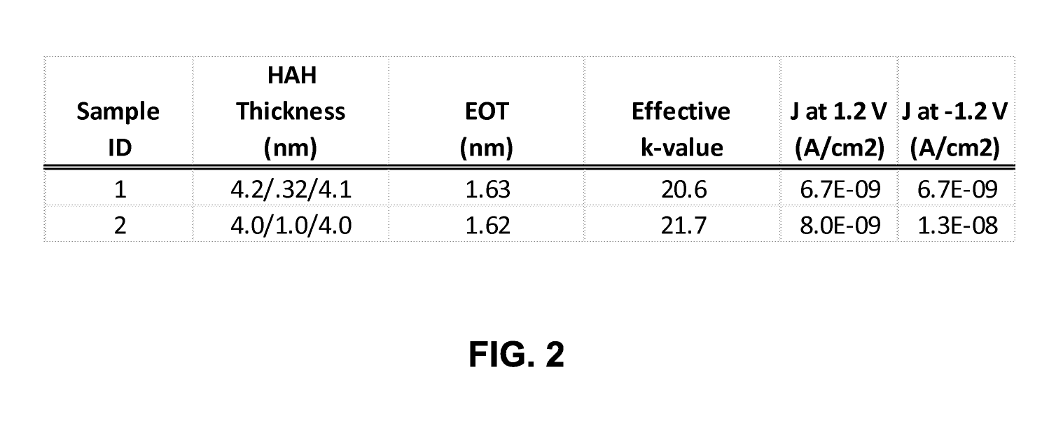

FIG. 2 presents a data table in accordance with some embodiments. Samples with ID=1 were deposited using an ALD technique wherein HfCl₄ was used as the hafnium precursor and ozone (e.g. at a concentration of 20 weight % in oxygen) was used as the oxidant. Samples with ID=2 were deposited using an ALD technique wherein HfCl₄ was used as the hafnium precursor and water was used as the oxidant.

In samples with ID=1, the use of ozone as the oxidant results in the hafnium oxide layers remaining amorphous. As discussed previously, this reduces the leakage current through the HAH stack. The thickness of the aluminum oxide layer was reduced to 0.32 nm. The EOT of the HAH stack was measured to be 1.63 nm. The leakage current density was measured to be less than 7E-09 at both +1.2V and at −1.2V.

In samples with ID=2, the use of water as the oxidant results in the hafnium oxide layers becoming crystalline. As discussed previously, this increases the leakage current through the HAH stack due to the presence of grain boundaries. The thickness of the aluminum oxide layer was increased to 1.0 nm. The EOT of the HAH stack was measured to be 1.62 nm. The leakage current density for these samples was higher than that of samples with ID=1 and was measured to be 8E-09 at +1.2V and 1.3E-08 at −1.2V. The effective k-value for the samples with ID=2 is larger than the effective k-value for the samples with ID=1. This trend may be attributed to the higher k-value for crystalline hafnium oxide versus a lower k-value for amorphous hafnium oxide.

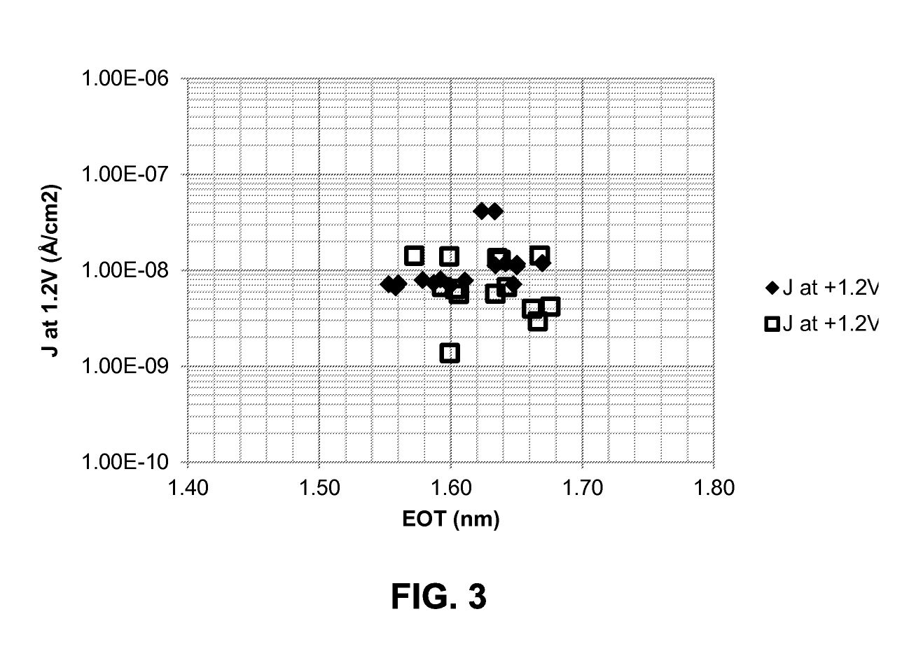

FIG. 3 presents data for current density versus EOT for capacitor stacks according to some embodiments. The data points indicated by the open squares correspond to the samples with ID=1 as summarized in FIG. 2. The data points indicated by the closed diamonds correspond to the samples with ID=2 as summarized in FIG. 2. Generally, the two sample populations overlap with respect to leakage current density and EOT.

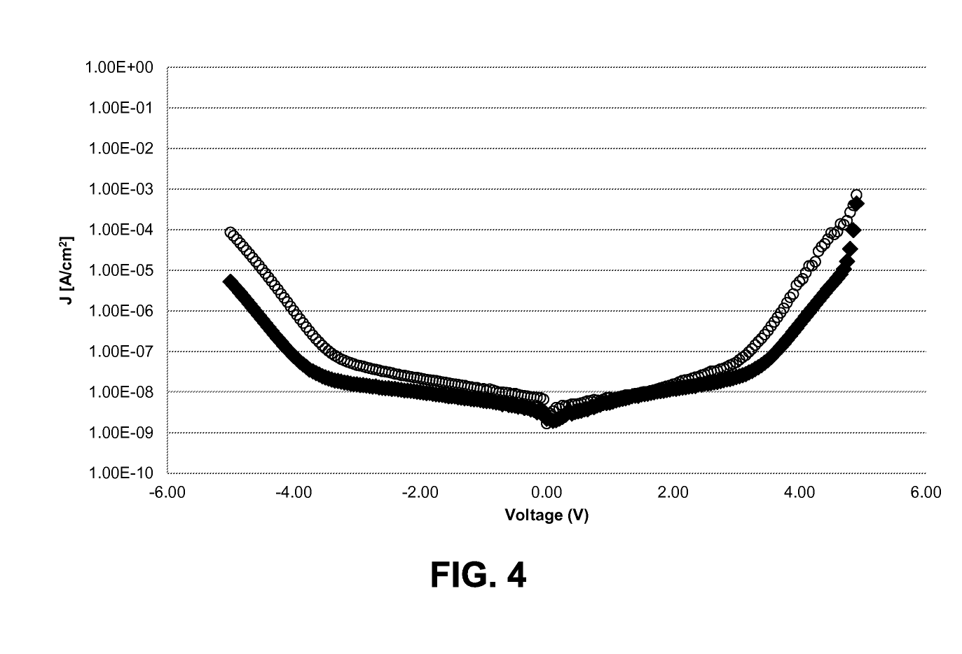

FIG. 4 presents data for current density versus voltage for capacitor stacks according to some embodiments. The data points indicated by the closed diamonds correspond to the samples with ID=1 as summarized in FIG. 2. The data points indicated by the open circles correspond to the samples with ID=2 as summarized in FIG. 2. The data indicate that the leakage current density is generally lower for the samples with ID=1 (i.e. the closed diamonds).

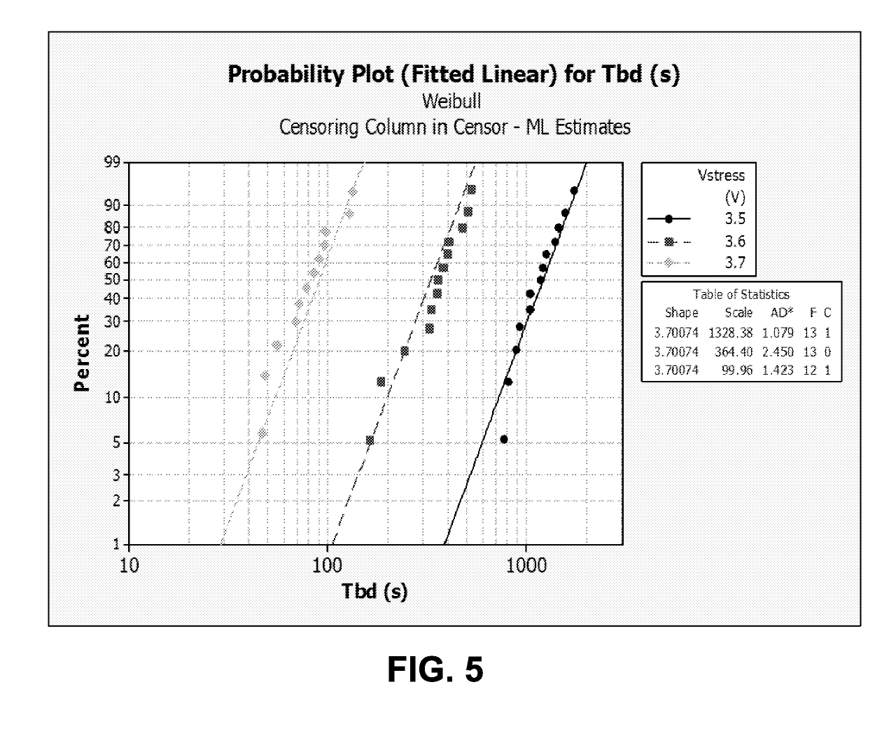

FIG. 5 presents data for failure probability versus time to break down for capacitor stacks according to some embodiments. These data are presented for samples with ID=1 as summarized in FIG. 2. Those skilled in the art will recognize this graph as a Weibull plot. The cumulative probability of breakdown as a function of time is plotted for three stress voltages (e.g. 3.5V, 3.6V, and 3.7V). At the highest stress voltage (i.e. 3.7V), 90% of the devices breakdown in less than 200 seconds. At the middle stress voltage (i.e. 3.6V), 90% of the devices breakdown in less than 500 seconds. At the lowest stress voltage (i.e. 3.5V), 90% of the devices breakdown in less than 2000 seconds.

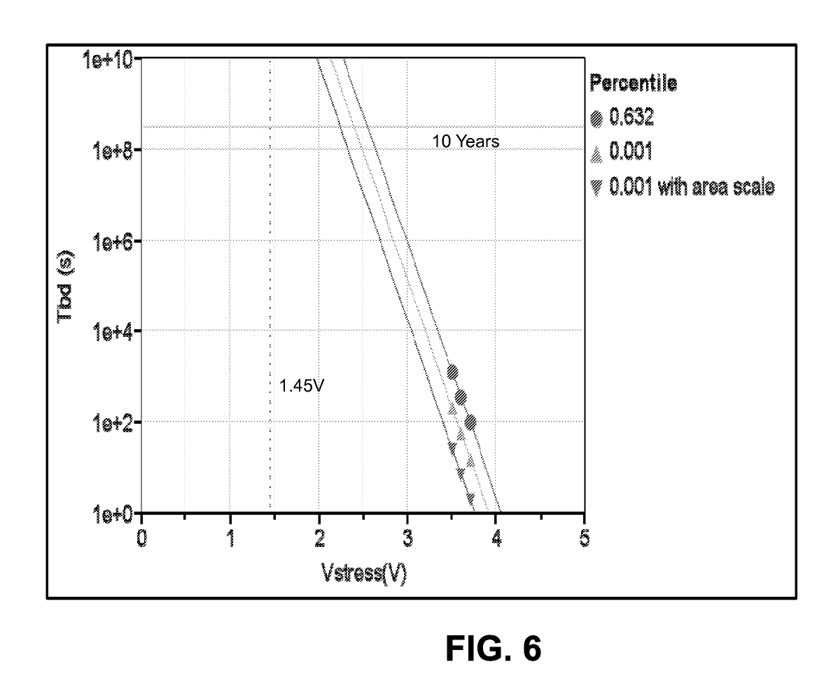

FIG. 6 presents data for time to break down versus stress voltage for various capacitor stacks according to some embodiments. These data are presented for samples with ID=1 as summarized in FIG. 2. Those skilled in the art will understand that the mean time to failure (MTTF) can be calculated using Eqn. 1:

Ln(MTTF)=c+k*Vₛₜᵣₑₛₛ Eqn. 1

Where “c” is a constant that is a function of the percentile in the Weibull distribution and Vₛₜᵣₑₛₛ is selected to be the operating voltage of 1.45V. For these data, k=−12.9. The MTTF ranges from a high of 4.75E14 seconds for the percentile=0.632 to a low of 8.71E12 seconds for the percentile=0.001 with the area scaled. Those skilled in the art will understand that all of these distributions are greater than the required lifetime of 10 years (˜3E8 seconds).

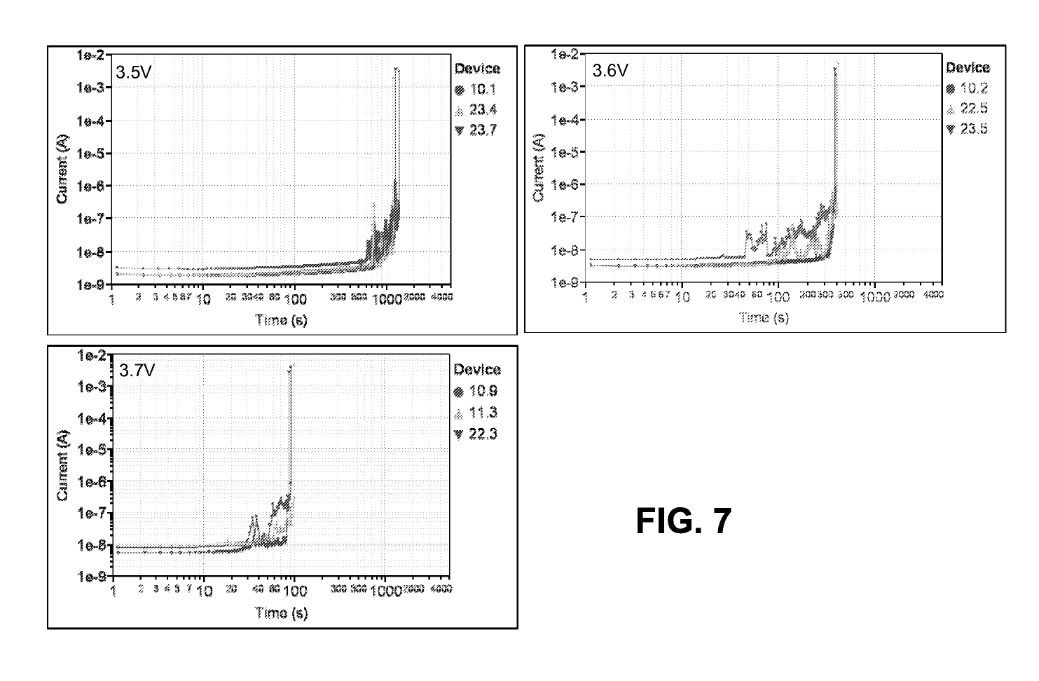

FIG. 7 presents data for current versus time for capacitor stacks at different stress voltages according to some embodiments. These data are presented for samples with ID=1 as summarized in FIG. 2. The data are presented for three stress voltages (e.g. 3.5V, 3.6V, and 3.7V). As discussed previously with reference to FIG. 5, at the highest stress voltage (i.e. 3.7V), essentially all of the devices breakdown in less than 200 seconds. Further, the devices begin to exhibit noise and/or soft breakdown at times after about 30 seconds. As discussed previously with reference to FIG. 5, at the middle stress voltage (i.e. 3.6V), essentially all of the devices breakdown in less than 500 seconds. Further, the devices begin to exhibit noise and/or soft breakdown at times after about 30 to 100 seconds. As discussed previously with reference to FIG. 5, at the lowest stress voltage (i.e. 3.5V), essentially all of the devices breakdown in less than 2000 seconds. Further, the devices begin to exhibit noise and/or soft breakdown at times after about 500 seconds.

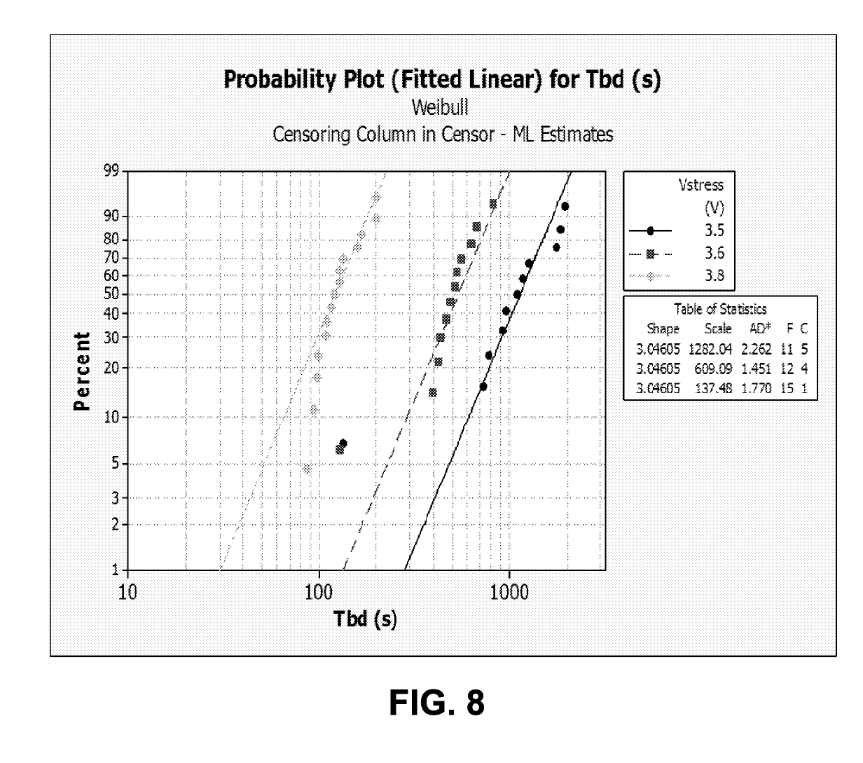

FIG. 8 presents data for failure probability versus time to break down for capacitor stacks according to some embodiments. These data are presented for samples with ID=2 as summarized in FIG. 2. Those skilled in the art will recognize this graph as a Weibull plot. The cumulative probability of breakdown as a function of time is plotted for three stress voltages (e.g. 3.5V, 3.6V, and 3.8V). At the highest stress voltage (i.e. 3.8V), 90% of the devices breakdown at or slightly higher than 200 seconds. At the middle stress voltage (i.e. 3.6V), 90% of the devices breakdown in about 800 seconds. At the lowest stress voltage (i.e. 3.5V), 90% of the devices breakdown in about 2000 seconds.

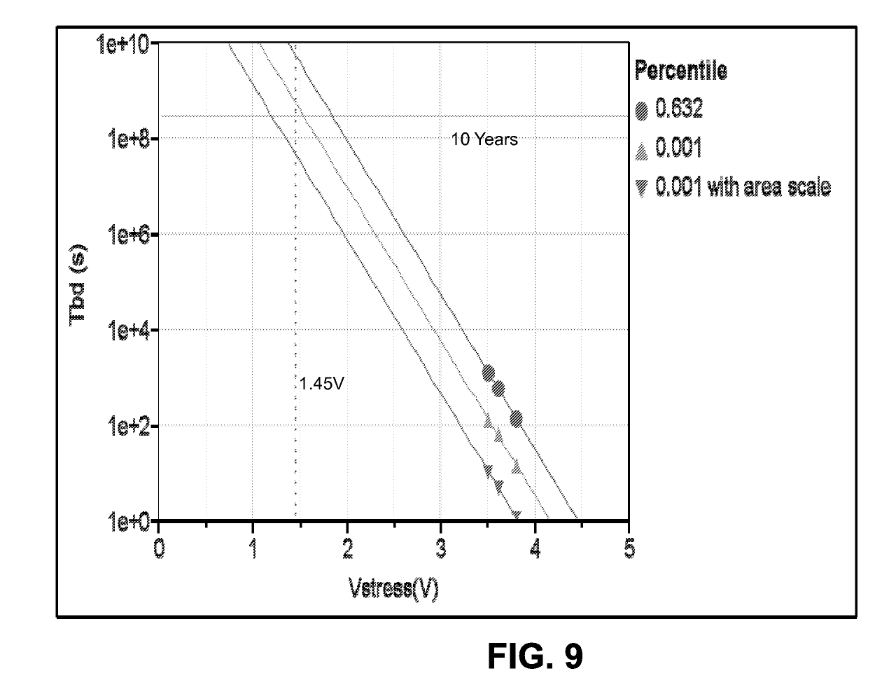

FIG. 9 presents data for time to break down versus stress voltage for various capacitor stacks according to some embodiments. These data are presented for samples with ID=2 as summarized in FIG. 2. Those skilled in the art will understand that the mean time to failure (MTTF) can be calculated using Eqn. 1 as discussed previously. As before, “c” is a constant that is a function of the percentile in the Weibull distribution and Vₛₜᵣₑₛₛ is selected to be the operating voltage of 1.45V. For these data, k=7.4. The MTTF ranges from a high of 5.74E9 seconds for the percentile=0.632 to a low of 4.72E7 seconds for the percentile=0.001 with the area scaled. Those skilled in the art will understand that the data with the percentile of 0.001 with the area scaled is less than the required lifetime of 10 years (˜3E8 seconds). Therefore, these devices do not meet the reliability specification.

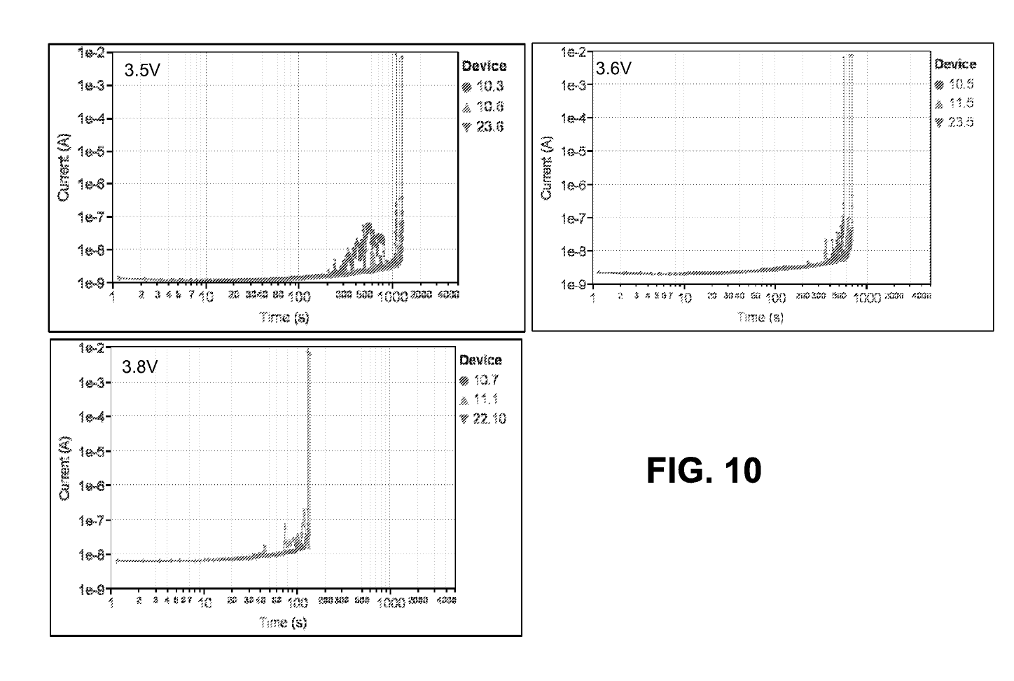

FIG. 10 presents data for current versus time for capacitor stacks at different stress voltages according to some embodiments. These data are presented for samples with ID=2 as summarized in FIG. 2. The data are presented for three stress voltages (e.g. 3.5V, 3.6V, and 3.8V). As discussed previously with reference to FIG. 8, at the highest stress voltage (i.e. 3.8V), essentially all of the devices breakdown in less than 200 seconds. Further, the devices begin to exhibit noise and/or soft breakdown at times after about 30 seconds. As discussed previously with reference to FIG. 8, at the middle stress voltage (i.e. 3.6V), essentially all of the devices breakdown in about 800 seconds. Further, the devices begin to exhibit noise and/or soft breakdown at times after about 300 to 400 seconds. As discussed previously with reference to FIG. 8, at the lowest stress voltage (i.e. 3.5V), essentially all of the devices breakdown in less than about 2000 seconds. Further, the devices begin to exhibit noise and/or soft breakdown at times after about 300 seconds.

The data in FIGS. 5-10 indicate that samples having ID=1 (e.g. having a thinner aluminum oxide layer and formed using ozone as the oxidant) exhibit improved reliability when compared to samples having ID=2 (e.g. having a thicker aluminum oxide layer and formed using water as the oxidant). As discussed previously, this may be attributed to the amorphous structure of the two hafnium oxide layers for the samples having ID=1 versus the crystalline structure of the two hafnium oxide layers for the samples having ID=2.

It is advantageous to form the high k sub-layers (e.g. hafnium oxide) so as to reduce the number of defects (e.g. oxygen vacancies and/or contaminants). As discussed previously, this will reduce the leakage current through the capacitor. One method used to form the high k material employs ALD for the deposition. As is well known in the art, ALD formation of a metal oxide includes alternating cycles of a metal precursor and an oxidant, typically with an inert gas purge between cycles. Common metal precursors include metal organic compounds and/or metal amine compounds. Common oxidants include water, oxygen, ozone, nitrous oxide, hydrogen peroxide, and the like.

As discussed previously, ozone is a common oxidant used in the formation of metal oxide dielectric materials. Ozone is typically delivered as a diluent within an oxygen stream. The concentration of ozone can be controlled between 0 and 20%. At higher ozone concentrations, the number of oxygen vacancies within the deposited metal oxide material is expected to be lower. This may also contribute to the lower leakage current observed for the samples formed using ozone as the oxidant.

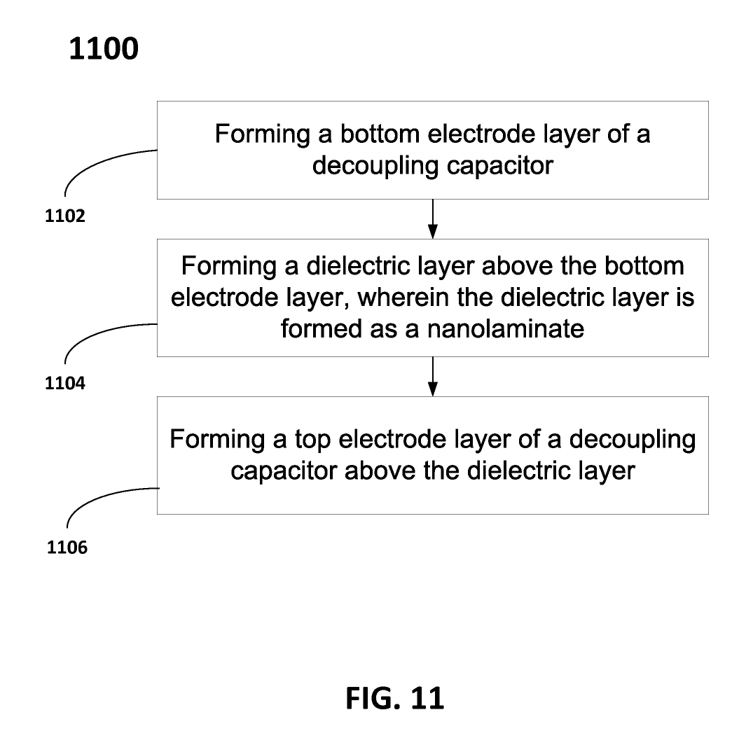

FIG. 11 illustrates a flow chart describing methods for fabricating capacitor stacks in accordance with some embodiments. In step 1102, a bottom electrode layer of a decoupling capacitor is formed above a surface of a substrate. Typically, the substrate includes logic circuits formed (either completely or in progress) thereon. Examples of suitable electrode materials include metals, metal alloys, conductive metal oxides, conductive metal silicides, conductive metal nitrides, doped polysilicon, or combinations thereof. Examples of suitable materials for the top electrode layer include titanium nitride, titanium aluminum nitride, titanium silicon nitride, tantalum nitride, tantalum aluminum nitride, tantalum silicon nitride, doped polysilicon, or combinations thereof. In some embodiments, the bottom electrode layer includes titanium nitride.

In step 1104, a multilayer dielectric stack is formed above the bottom electrode layer. In some embodiments, the multilayer dielectric stack is formed as a nanolaminate of a high k material and a high band gap material. In some embodiments, the high k material includes hafnium oxide. In some embodiments, the high band gap material includes aluminum oxide. In some embodiments, the multilayer dielectric stack includes hafnium oxide-aluminum oxide-hafnium oxide. In some embodiments, the thickness of each of the hafnium oxide layers is between about 3.0 nm and about 4.5 nm. In some embodiments, the thickness of the aluminum oxide layer is between about 0.1 nm and about 1.0 nm. In some embodiments, ozone is used as an oxidant during the deposition of the multilayer dielectric stack. In some embodiments, the concentration of the ozone is 20% by weight.

In step 1106, a top electrode layer of a decoupling capacitor is formed above the dielectric layer. Typically, the substrate includes logic circuits formed (either completely or in progress) thereon. Examples of suitable electrode materials include metals, metal alloys, conductive metal oxides, conductive metal silicides, conductive metal nitrides, doped polysilicon, or combinations thereof. Examples of suitable materials for the top electrode layer include titanium nitride, titanium aluminum nitride, titanium silicon nitride, tantalum nitride, tantalum aluminum nitride, tantalum silicon nitride, doped polysilicon, or combinations thereof. In some embodiments, the top electrode layer includes titanium nitride.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A capacitor comprising:
a bottom electrode layer above a surface of a substrate;
a first dielectric layer above the bottom electrode layer, wherein the first dielectric layer comprises a high k material;
a second dielectric layer above the first dielectric layer, wherein the second dielectric layer comprises a high bandgap material;
a third dielectric layer above the second dielectric layer, wherein the third dielectric layer comprises a high k material; and
a top electrode layer above the third dielectric layer.

2. The capacitor of claim 1, wherein the bottom electrode layer comprises one or more of titanium nitride, titanium aluminum nitride, titanium silicon nitride, tantalum nitride, tantalum aluminum nitride, tantalum silicon nitride, or doped polysilicon.

3. The capacitor of claim 1, wherein the bottom electrode layer comprises titanium nitride.

4. The capacitor of claim 1, wherein the first dielectric layer and the third dielectric layer each comprise hafnium oxide.

5. The capacitor of claim 1, wherein the second dielectric layer comprises aluminum oxide.

6. The capacitor of claim 1, wherein the top electrode layer comprises one or more of titanium nitride, titanium aluminum nitride, titanium silicon nitride, tantalum nitride, tantalum aluminum nitride, tantalum silicon nitride, or doped polysilicon.

7. The capacitor of claim 1, wherein the top electrode layer comprises titanium nitride.

8. The capacitor of claim 1, wherein each of the first dielectric layer, the second dielectric layer, and the third dielectric layer is formed by ALD deposition.

9. The capacitor of claim 8, wherein ozone is used as an oxidant during the deposition of each of the first dielectric layer, the second dielectric layer, and the third dielectric layer.

10. The capacitor of claim 9, wherein a concentration of the ozone is 20% by weight during the deposition of each of the first dielectric layer, the second dielectric layer, and the third dielectric layer.

11. The capacitor of claim 1, wherein each of the first dielectric layer and the third dielectric layer comprises hafnium oxide and each of the first dielectric layer and the third dielectric layer has a thickness of between 3.0 nm and 4.5 nm, and wherein the second dielectric layer comprises aluminum oxide and the second dielectric layer has a thickness between 0.1 nm and 1.0 nm.

12. A method of forming a capacitor for use in a microelectronic logic circuit, the method comprising:
forming a bottom electrode layer above a surface of a substrate;
forming a first dielectric layer above the bottom electrode layer, wherein the first dielectric layer comprises a high k material;
forming a second dielectric layer above the first dielectric layer, wherein the second dielectric layer comprises a high bandgap material;
forming a third dielectric layer above the second dielectric layer, wherein the third dielectric layer comprises a high k material; and
forming a top electrode layer above the third dielectric layer.

13. The method of claim 12, wherein the bottom electrode layer comprises one or more of titanium nitride, titanium aluminum nitride, titanium silicon nitride, tantalum nitride, tantalum aluminum nitride, tantalum silicon nitride, or doped polysilicon.

14. The method of claim 13, wherein the bottom electrode layer comprises titanium nitride.

15. The method of claim 12, wherein each of the first dielectric layer and the third dielectric layer comprises hafnium oxide.

16. The method of claim 12, wherein the second dielectric layer comprises aluminum oxide.

17. The method of claim 12, wherein the top electrode layer comprises one or more of titanium nitride, titanium aluminum nitride, titanium silicon nitride, tantalum nitride, tantalum aluminum nitride, tantalum silicon nitride, or doped polysilicon.

18. The method of claim 17, wherein the top electrode layer comprises titanium nitride.

19. The method of claim 12, wherein each of the first dielectric layer and the third dielectric layer comprises hafnium oxide and each of the first dielectric layer and the third dielectric layer has a thickness of between 3.0 nm and 4.5 nm, and wherein the second dielectric layer comprises aluminum oxide and the second dielectric layer has a thickness between 0.1 nm and 1.0 nm.
